(19) United States
(12) Patent Application Publication
(10) Pub. No.: US 2004/0166334 A1
(43) Pub. Date: Aug. 26, 2004

(54) Decorative film-like material

(76) Inventor: Shigeo Kawabata, Osaka-shi (JP)

Correspondence Address: Parker DeStefano, Suite 300, 300 Preston Avenue, Charlottesville, VA, 22902, US

(21) Appl. No.: 10/375,695

(22) Filed: Feb. 26, 2003

(51) Int. Cl. B32B 3/00

(52) U.S. Cl. 428/457; 428/200; 428/461

(57) ABSTRACT

The present invention relates to a decorative film-like material having a plating toned metallic luster. A decorative film-like material has a primer layer, a decorative layer and a curable resin layer. The decorative layer has a metal thin layer.

### BACKGROUND OF THE INVENTION

1. Field of the Invention

The present invention relates to a decorative film-like material which can be preferably used when the effect of mirror surface is required as a design for construction components including exterior walls, street doors and exteriors and interiors of vehicles and vessels, billboards and signs. It also relates to an automobile with the decorative film-like material, automobile parts with the decorative film-like material and a method of manufacturing the decorative film-like material.

2. Description of Related Art

The following description sets forth the inventor's knowledge of related art and problems therein and should not be construed as an admission of knowledge in the prior art.

For example, in order to improve the design of constructions component, such as exterior walls, street doors and exteriors and interiors of vehicles and vessels, billboards and signs, a decorative sheet with color, etc. is adhered thereon or a decorative film-like material is bonded to a substrate thereof.

As a decorative film-like material excellent in design and workability, a decorative coating film-like material consisting of a print ink layer printed on a releasing surface of a releasing sheet and having a releasing property to the releasing surface and a coating layer formed by curing a resin applied on a surface of said printed ink layer, the resin being selected from the group consisting of a heat-curable resin, an electron ray-curing resin, a radiation-curable resin and an ultraviolet-rays-curing resin (see Japanese Unexamined Laid-open Patent Publication 2001-1483).

According to the aforementioned technology, a decoration of a substrate can be easily performed at operational sites by bonding or adhering the decorative film-like material, which is excellent in design and abrasion-resistance, on the substrate.

In the aforementioned technology, in cases where metallic luster is to be given to the decorative film-like material, it is considered to form a printed layer by using metal pigments and the binder components in the printing process.

However, in the print layer of the decorative film-like material obtained by the aforementioned method, since the individual metal particles are simply bonded by the binder components, even in cases where a mirror surface effect is desired, the print layer becomes a metallic tone due to the irregular reflection by the metal particles in the print layer. Therefore, a decorative film-like material having a plating tone cannot be obtained.

In this specification, a metallic tone is defined as providing a feeling of a metal surface with a coated film by applying a coating including metal powder pigments. On the other hand, a plating tone is defined as providing a feeling of a uniform metal surface without diffuse reflection obtained by reflection of metal thin layers.

Further, it was difficult to make a thickness of a print layer not greater than 10 ▪m to print layers having a metal evenly by a printing process. Thus, with the above technology, it has been impossible to produce decorative film-like materials with good designs having a metal reflection effect while maintaining transparency as well.

Therefore, in order to obtain a decorative film-like material having a plating tone effect using a production method of the above technology, it is assumed to print only a layer called a foundation layer disclosed in the above document in the above mentioned printing process thereafter forming a metal thin layer by using an electrolytic plating method or a usual forming method of metal thin layers.

However, in order to adopt an electrolytic plating method, it is necessary to make a releasing sheet for printing conductive and further, it is necessary not to let a foundation layer dissolve in electrolytic solution. Further, large scale devices must be provided and thus, it is not effective in view of cost effectiveness.

On the other hand, even though efforts are made to form a metal thin layer by simply forming a metal thin layer on a foundation layer by adopting method of metal thin layers including a spattering method or a vapor deposition method, since a foundation layer repels spattered metal or deposited metal, a metal thin layer has not been formed. Even in trying to solve this problem by enhancing accelerating energy of ion particles in a spattering method, for example, since spattered metal particles pass through a foundation layer and metal is built up directly on a releasing sheet for printing, it is impossible to transcribe a metal thin layer on a decorative film-like material and so such a decorative film-like material could not be obtained to the last.

Therefore, with such decorative film-like materials as obtained by the above technology, it has been difficult to apply for exterior and interior of vehicles and vessels including automobile mirror parts, automobile bumper parts, automobile bodies, and the like, in which a plating tone effect as a design is particularly required.

It is an object of the present invention to provide a decorative film-like material excellent in design, abrasion resistance and workability at operational sites, more specifically, a decorative film-like material having a plating-like design.

It is another object of the present invention to provide an automobile parts with the aforementioned decorative film-like material.

It is still another object of the present invention to provide an automobile with the aforementioned decorative film-like material.

It is still yet another object of the present invention to provide a method of manufacturing the decorative film-like material.

### SUMMARY OF THE INVENTION

According to the first aspect of the present invention, a decorative film-like material, comprises:

a primer layer;

a decorative layer formed on the primer layer; and

a curable resin layer formed on the decorative layer,

wherein the curable resin layer is a layer selected from the group consisting of a heat-curable resin layer and a radiation-curable curable resin layer, and

wherein the decorative layer includes a metal thin layer.

It is preferable that the curable resin layer is a cured resin layer formed by curing a resin applied on a surface of the decorative primer layer.

It is preferable that the primer layer is formed by printing a resin on a releasing sheet and has a release characteristic to the releasing sheet.

It is preferable that the primer layer includes a cross-linking agent.

It is preferable that the metal thin layer has a thickness of less than 10 ▪m.

According to the second aspect of the present invention, automobile parts are provided with the decorative film-like material as recited in claim 1 adhered thereon.

According to the third aspect of the present invention, an automobile, comprises:

an automobile body; and

a decorative film-like material as a coating layer adhered on a surface of the automobile body via an adhesive layer,

wherein the decorative film-like material includes a primer layer, a decorative layer formed on the primer layer and a curable resin layer formed on the decorative layer, the curable resin layer being a layer selected from the group consisting of a heat-curable layer and a radiation-curable curable resin layer, and the decorative layer including a metal thin layer, and wherein the adhesive layer is disposed between the primer layer and the surface of the automobile body.

According to the fourth aspect of the present invention, a method for manufacturing a decorative sheet, comprises:

printing a resin including a cross-linking agent on a releasing surface of a releasing sheet to thereby form a primer layer having a releasing property;

forming a decorative layer as a metal thin layer on the primer layer by a spattering method;

applying a curable resin selected from the group consisting of a heat-curable resin and a radiation-curable resin on the decorative layer in a state that the primer layer on which the decorative layer is formed is adhered to the releasing sheet; and

curing the curable resin applied on the decorative layer to thereby form a cured resin layer.

According to the fifth aspect of the present invention, a method for manufacturing a decorative film-like material, comprises:

printing a resin including a cross-linking agent on a releasing surface of a releasing sheet to form a primer layer having a releasing property;

forming a decorative layer as a metal thin layer on the primer layer by a deposition method;

applying a curable resin selected from the group consisting of a heat-curable resin and a radiation-curable resin on the decorative layer in a state that the primer layer on which the decorative layer is formed is adhered to the releasing sheet; and

curing the resin applied on the decorative layer to form a cured resin layer.

According to the aforementioned decorative film-like material and a method for manufacturing the same, a decorative film-like material with a plating-like design or a decorative film-like material having a metallic luster while maintaining transparency, which have not been realized by a technology disclosed in Japanese Unexamined Patent Publication 2001-1483, can be obtained. In addition, the present invention can provide an effective method of manufacturing such a decorative film-like material.

Other objects and the features will be apparent from the following detailed description of the present invention with reference to the attached drawings.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF DRAWING

The accompanying figures are provided by way of example, without limiting the broad scope of the invention or various other embodiments, wherein:

FIG. 1 is a sectional view showing a decorative film-like material in an embodiment of the present invention;

FIGS. 2(a) to 2(d) are sectional views showing a process flow of a production method of a decorative film-like material in an embodiment of the present invention;

FIG. 2(a) is a sectional view showing the first process of a production method of a decorative film-like material in an embodiment of the present invention;

FIG. 2(b) is a sectional view showing the second process of a production method of a decorative film-like material in an embodiment of the present invention;

FIG. 2(c) is a sectional view showing the third process of a production method of a decorative film-like material in an embodiment of the present invention; and

FIG. 2(d) is a sectional view showing the fourth process of a production method of a decorative film-like material in an embodiment of the present invention.

### DETAIL DESCRIPTION OF THE PREFERRED EMBODIMENTS

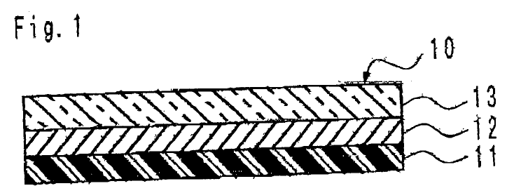

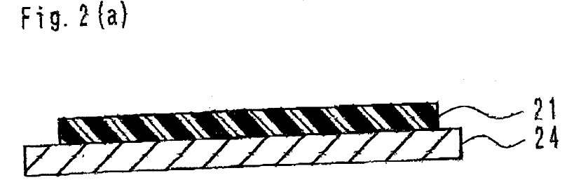

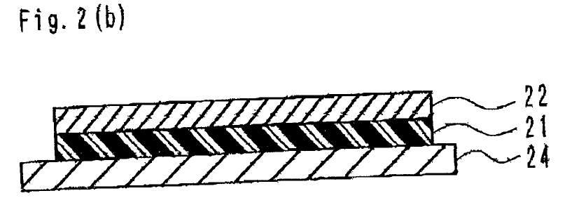

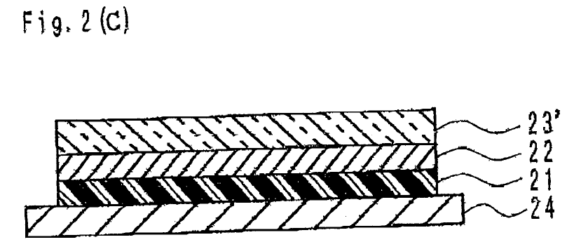

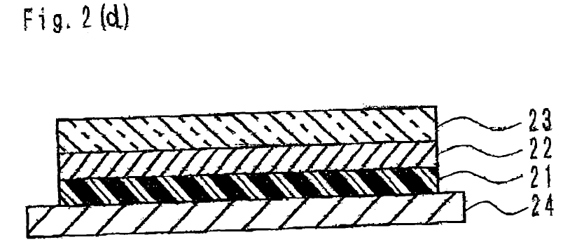

A decorative film-like material according to embodiments of the present invention will be explained with reference to FIGS. 1 and 2.

The decorative film-like material 10 has a primer layer 11, a decorative layer 12 formed on the primer layer 11 and a curable resin layer formed on the decorative layer 12. The decorative layer 12 is formed by curing a curable resin applied on a surface of the decorative layer 12 so as to cover the surface by heat or radiation. The decorative layer 12 includes a metal thin layer.

The primer layer 11 contains a cross-linking agent. The primer layer 11 is preferably formed on a releasing surface of a releasing sheet 24 and has a releasing property to the releasing surface. Therefore, it is required that the primer layer 11 has a good releasing property to the releasing sheet 24 and a property for easily building up a metal thin layer as a decorative layer thereon. The primer layer 11 may be made of, for example, a polyester resin, an alkyd resin, an amino resin, an acrylic resin, an epoxy resin or a vinyl chloride resin. In cases where resins having compatibility are used for the primer layer 11, these resins can be mixed or can be used in a state of built-up layers.

On the other hand, a silicon resin and a fluoride resin having small surface tension are not suitable for the resin constituting the primer layer 11, although a releasing property to a releasing sheet can be obtained by selecting an appropriate material of the releasing sheet, since it is difficult to form a metal thin layer thereon even if a cross-linking agent, which will be explained later, is added to such a resin.

The thickness of the primer layer 11 is not specifically limited. The preferable thickness is about 0.3 to 50 ▪m because of the following reasons. If the thickness of the primer layer 11 exceeds the upper limit, the flexibility of the decorative film-like material 10 deteriorates. Therefore, in cases where the decorative film-like material 10 is applied to a substrate having an uneven surface, the decorative film-like material 10 may not be well fitted to the substrate. On the other hand, if the thickness of the primer layer 11 is less than the lower limit, the releasing property to the releasing sheet deteriorates. It is more preferable that the thickness falls within the range of 1 to 10 ▪m.

The primer layer 11 contains a cross-linking agent for enabling a building up of a metal thin layer 12 causing a metal plating-like design effect thereon. As the cross-linking agent, isocyanate cross-linking agents, epoxy cross-linking agents and aluminum chelate cross-linking agents can be exemplified.

Although the detailed mechanism that the cross-linking agent mixed in the primer layer 11 enables the metal thin layer 12 to be built up on the primer layer 11 is not clear, it is assumed that the cross-linking agent enhances a capture of metal particles by the three dimensional structure formed by molecular chains constituting the primer layer 11.

In order to obtain a plating-like design effect to be observed from the curable resin layer side 13, the decorative layer 12 may be a metal thin layer formed by a known method of making a metal thin layer such as a spattering method or a vapor deposition method. In this case, the metal is not limited to a specific one so long as it is capable of forming a metal thin layer. Especially, a spattering method can be preferably adapted because any metal can be used to form a metal thin layer even if it is a low vapor pressure metal. Examples of such metals include chrome, aluminum, titanium, gold and silver. In addition, an alloy including several kinds of metals can be used. By selecting the kind of metal, a colorless or colored metallic luster caused by the color of the metal can be obtained.

The thickness of the decorative layer 12 is not specifically limited. In cases where a metal thin layer is used as the decorative layer 12, however, the thickness of the metal thin layer is not required to be 10 ▪m thick or more since a plating-like design can be obtained even if the thickness is about a few ▪m. In cases where the decorative layer 12 is formed by a spattering method or a vapor deposition method, a thickness less than 10 m, which was difficult to obtain by a printing method, can be easily obtained. Thus, a decorative film-like material 12 having a thickness of 0.1 ▪m or less and a specific transparent design with a metal reflection effect can be obtained.

In the step of forming a metal thin layer, by adopting a blocking plate with a specific configuration/pattern, a layer having a plating-like design effect can be formed only in a required portion.

Furthermore, the decorative layer 12 may be a combination of a metal thin layer and a print layer formed on the metal thin layer formed by a printing method with ink. In this case, when in use, a specific design caused by the combination of the metal thin layer and the printing layer can be observed from the curable resin layer side. As for the ink to be used for the print layer, any known ink can be used. For example, acrylic resin ink, fluoride resin ink, inorganic resin in or the like can be exemplified. In this step, since the printing is conducted after forming the metal thin layer, a fluoride resin or the like can be used.

As for a resin used for the aforementioned curable resin layer formed on the decorative layer 12, any known resin can be used as long as it is a non-solvent type curable resin. For example, simple substance of light-cured olygomers having double bond including acrylic group, methacrylic group, allyl group and vinyl group (for example, urethane acrylate resin) and monomers (for example, tripropylene glycol diacrylate) or compounds thereof are preferably used as main components. From a view point of designs in which the patterns of the decorative film-like material 12 and the like can be clearly observed, it is preferable that the curable resin layer 13 is transparent. However, the decorative film-like material 10 may be colored transparency including coloring components. The coloring components may be any known pigments.

Furthermore, as required, ultra violet ray absorbent, other light stabilizer, anti-oxidant, anti-aging agent, leveling agent, anti-static agent, fixing agent, plasticizer, lubricant, inorganic filler, organic filler, such metal (compound) oxide fine particles including titanium oxide, zinc oxide, ITO and the like having ultra violet ray absorption power or near-infrared ray absorption power can be added as additives in the curable resin layer 13.

The curable resin layer 13 may be constituted by built up layers. In this case, these layers may contain different coloring components respectively. In cases where the curable resin layer 13 is comprised of multiple layers each having different coloring components, the design can further be improved. Also, an additional metal thin layer may be provided on the surface of the curable resin layer 13.

It is preferable that the thickness of the curable resin layer 13 falls within the range of 5 to 500 ▪m. If the thickness of the curable resin layer 13 is less than 5 ▪m, the protection effect of the decorative later 12 becomes insufficient. On the other hand, if the thickness exceeds 500 ▪m, the flexibility of the decorative film-like material 10 deteriorates, resulting in poor handling. It is more preferable that the thickness is 10 to 300 ▪m.

The method of forming the curable resin layer 13 is not specifically limited. For example, the curable resin layer 13 can be formed by applying a curable resin compositions on the surface of the decorative layer 12 to form a curable resin layer having a predetermined thickness and then heating the resin layer or irradiating ultra violet rays, electron rays, radiation or the like to the resin layer. The application of the curable resin components onto the surface of the decorative layer 12 can be performed by a bar coat method, a roll coat method, an air doctor coat method, a blade coat method, a squeeze coat method, an air knife coat method, a reverse roll coat method, a gravure coat method, a transfer coat method, a fountain coat method, a slit die coat method or a lip die coat method. In cases where an electron-curable resin is used as the curable resin, an electron irradiation device to be used is not specifically limited. For example, a Van der Graaff scanning type electron irradiation device, a double scanning type electron irradiation device or a curtain beam type electron irradiation device can be used. Especially, it is preferable to use a curtain beam type electron irradiation device which is relatively low in cost and has a strong electron radiation output. Depending on the thickness of the curable resin layer, the acceleration voltage should be adjusted. The electron irradiation atmosphere should be performed in an inert gas atmosphere, such as a nitrogen gas atmosphere, in which oxygen, ozone or the like is not contained.

It is preferable that the acceleration voltage at the time of the electron irradiation is 100 to 500 kV. In order to increase the electron transmission rate, the acceleration voltage is preferably 250 kV or more. The electron absorption dose is not specifically limited as long as the electron-curable resin compositions can be cured in a predetermined degree. Generally, the absorption dose is 0.1 to 7Mrad, more preferably 0.2 to 5Mrad. If the electron absorption dose is less than 0.1Mrad, the curing of the resin composition by the electron irradiation is insufficient. On the other hand, if the electron absorption dose exceeds 7Mrad, the seat-like substrate may be deteriorated or the color may be changed. Furthermore, it is not preferable from a view point of energy saving.

The surface of the curable resin layer 13 may be covered by a protection film. The protection film is not limited to a specific one as long as the film has an easy-to-peel-off property to the curable resin layer 13 and the material is not likely to migrate with the resin constituting the curable resin layer 13. For example, the protection film may be constituted by a resin film made of polyethylene or polyethylene terephthalate (PET) and a releasing layer including a releasing agent coated on the curable resin layer 13.

As for the releasing sheet 24 on which the aforementioned decorative film-like material 10 is temporarily adhered, it is not specifically limited as long as the primer layer 11 can be easily released from the releasing sheet 24. The examples of the releasing sheet 24 include a paper substrate such as a quality paper, a coated paper, a cast coated paper and an art paper, a film-like synthetic resin sheet such as a synthetic paper, a polyethylene sheet, a polypropylene sheet, a polyester sheet, a polyamide sheet and a polyvinyl chloride sheet, a laminated paper with polyolefin resin layers formed on one surface or both surfaces, one of the aforementioned sheet on which a releasing layer is provided on the releasing surface and one of the aforementioned sheet whose releasing property is modified by corona treatment In other words, the releasing sheet 24 may be a sheet having appropriate bonding/releasing properties to the primer layer 11.

For the purpose of improving the adhesiveness between the curable resin layer 13 and the decorative layer 11, a secondary primer layer may be disposed therebetween. Although the resin constituting the secondary primer layer is not specifically limited, it is preferable to use a resin containing 25% by weight or more of a cured material of a radiation-curable resin made of acrylic oligomer and/or an acrylic resin. In this case, a decorative film-like material 10 or a decorative sheet excellent in weather resistance, abrasion resistance, solvent resistance and chemical resistance with little contraction rate can be provided.

Furthermore, the aforementioned decorative film-like material 10 can be served as a decorative sheet (not shown) including an additional adhesive layer (not shown) provided on the releasing surface of the aforementioned primer layer 11 and a peel-off sheet (not shown) adhered on the additional adhesive layer. The adhesive constituting the adhesive layer may be a known adhesive. The examples include acrylic adhesive J which contains both acrylic polymer and tackifier. The peel-off sheet is not specifically limited as long as it is not bonded to the adhesive, and may be a film type sheet made of, for example, a polyethylene terephtalate, a polyethylene or a polypropylene or a paper-like sheet including a quality paper and kraft paper on which a releasing agent including silicon is coated.

When in use, in cases where the decorative film-like material 10 is supplied with the aforementioned releasing sheet, a bonding agent is applied to the primer layer 11 of the decorative film-like material 10 from which the releasing sheet was released, or an adhesive agent is applied to a substrate surface to which the decorative film-like material 10 is to be adhered. Thereafter, the decorative film-like material 10 from which the releasing sheet was released is fitted on a substrate surface to thereby be integrally adhered thereon via the adhesive agent.

This decorative film-like material 10 can be used as a paintless film used for a blow molding method, an insert molding method, a film in molding method, a SMC molding method, a PFM molding method, and the like.

On the other hand, in cases where the decorative sheet is supplied with the aforementioned additional adhesive layer provided on the releasing surface of the primer layer 11 and the aforementioned peel-off sheet (not shown) adhered on the additional adhesive layer, it can be used by peeling off the peel-off sheet and adhering to a substrate via the additional adhesive layer.

(Production Method)

Next, a preferable method for easily manufacturing the decorative film-like material 10 according to the present invention will be detailed with reference to FIG. 2.

As a preparation step for manufacturing the film-like material 10, a cross-linking agent is mixed to a resin constituting the primer layer 21 as above mentioned. The mixing method may be any known method. It is preferable that the mixing ratio of the cross-link agent to the resin falls within the range of 0.02 to 6%. If the mixing ratio is lower than the lower limit, it becomes impossible to form a metal thin layer on the primer layer 21. On the other hand, if the mixing ratio exceeds the upper limit, it becomes difficult to release the film-like material 10 from the releasing sheet.

In the first step for manufacturing the decorative film-like material 10 of the present invention, as shown in FIG. 2(a), a resin including a cross-linking agent is printed on a releasing surface of a releasing sheet 24 to thereby form a primer layer 21.

In the second step, as shown in FIG. 2(b), the material obtained in the first step is disposed in a vacuum atmosphere, and a metal thin layer as the decorative layer 22 is formed on the primer layer 21 by a spattering method This step can be performed at the degree of vacuum of about 10⁻¹ Pa since the degree of vacuum at this step can be the same as the conditions for forming a usual metal thin layer. Although the metal thin layer forming speed depends on metals, it is preferable that the forming speed is about 0.1 to 20 ▪m/minute. If the forming speed exceeds the upper limit, spattered metal particles go through the primer layer 21 to be formed directly on the releasing sheet 24. On the other hand, if the speed is lower than the lower limit, the operational efficiency becomes poor.

Further, instead of the aforementioned second step, a vapor deposition method can be applied for the second step. As shown in FIG. 2(b), the releasing sheet 24 with the primer layer 21a obtained in the first step is disposed in a vacuum atmosphere, and a metal thin layer as the decorative layer 22 is formed on the primer layer 21 by a vapor deposition method. This step can be performed at the degree of vacuum of about 10⁻³ Pa since the degree of vacuum at this step can be the same as the conditions for forming a usual metal thin layer. Although the metal thin layer forming speed depends on metals, it is preferable that the forming speed is about 0.1 to 5 ▪m/minute. If the forming speed exceeds the upper limit, spattered metal particles go through the primer layer 21 to be formed directly on the releasing sheet 24. On the other hand, if the speed is lower than the lower limit, the operational efficiency becomes poor.

In cases where the decorative film-like material 22 is constituted by a metal thin layer and a print layer, the print layer can be formed by printing a resin containing a coating on the surface of the metal thin layer by a known printing process.

Further, in cases where the decorative film-like material includes a secondary primer layer, the secondary primer layer can be formed by coating a heat-curable resin or a radiation-curable resin on the material obtained in the second step. For example, in the case of using a electron-curable resin, non-solvent type electron-curable resin coating 23′ which will form the curable resin layer 23 on the decorative layer 22.

In the fourth step, as shown in FIG. 2(d), the non-cured resin obtained in the third step is cured. For example, in the case of using the non-solvent type electron-curable resin coating 23′, the intermediate obtained in the third step in a non-cured state is disposed in an electron irradiation device, and electron is irradiated to the material to thereby form a cured resin layer 23.

By releasing the releasing sheet 24 from the material obtained by the aforementioned steps, the decorative film-like material 10 can be obtained. In order to obtain an adhesive decorative sheet from the decorative film-like material 10, an adhesive is applied to a peel-off sheet, then this peel-off sheet is adhered to the primer layer side of the decorative film-like material 10 and kept at a temperature of 50▪ for three (3) days, a decorative sheet using the decorative film-like material 10 of the present invention can be obtained.

Since the decorative film-like material 10 obtained by the method explained above is excellent in design, abrasive resistance and workability at operation sites and is a decorative film-like material suitably used when a plating-like design is required, the decorative film-like material of the present invention can preferably be used not only for construction components including walls, columns and doors, for billboards or signs as well as exteriors and interiors of vehicles and vessels including automobile mirror parts and bumper parts, or bodies, and the like.

### EXAMPLES

Hereinafter, the examples of the present invention will be explained in detail.

### Example 1

Aromatic isocyanate as a cross-linking agent (trade name: L-55 E, manufactured by Nippon Polyurethane Industry Co., Ltd) was mixed to an acrylic resin with substantial ratio of 1%. Then, a resin component containing the cross-linking agent was solidly printed on a whole surface of a releasing surface of a releasing sheet with releasing auxiliary layer provided on a surface of a 32 ▪m thick untreated polyester film (manufactured by Toyobo Co., Ltd) to thereby form a 10 ▪m thick primer layer.

Next, this sheet was placed in a spattering device and a decorative layer was produced by building up silver in 1 ▪m thick on this primer layer by a spattering method with a building up speed of 10 ▪m/minute in a vacuum state of 2×10⁻¹% Pa. This sheet with the decorative layer was taken out and a transparent non-solvent type electron ray resin coating (main component thereof is a compound of urethane acrylate resin and tripropylene glycoldiacrylate manufactured by SANYU-PAINT Co., Ltd) was applied on the decorative layer by a gravure coating method to form a resin coating layer of a thickness of 75 ▪m.

Then, in a state where a polyester emboss film (manufactured by Toyobo Co., Ltd) as a protection film having an uneven surface was fitted on the resin coating layer with the uneven surface fitted on the resin coating layer, this sheet was disposed in an electron ray irradiation device (manufactured by NISSIN ELECTRIC CO., LTD, with a curtain beam method) in a nitrogen gas atmosphere, and 4 Mrad electron ray with an acceleration voltage of 250 kV was irradiated thereto so as to cure the resin layer to thereby obtain a cured resin layer. Thus, a decorative film-like material was obtained. The releasing sheet was released and an acrylate resin adhesive was applied to the exposed primer layer, and then the decorative film-like material was integrally bonded to a surface of wooden board as a substrate via the adhesive, followed by removing the protection film. Thus, a decorative board was obtained.

The obtained decorative board had a plating tone finish and had even silver metallic luster when observed from the curable resin layer.

### Example 2

The same steps as in Example 1 were applied except that a decorative later was formed by a vapor deposition method instead of using a spattering process of Example 1. The vacuum degree was set to be 3×10⁻³ Pa and the building-up speed was set to be 2 ▪m/minute. Next, an acrylic adhesive (X-0589 manufactured by VIG TEQNOS LTD) was applied to a primer layer in which a decorative film-like material was exposed and an adhesive layer was formed. This was adhered to a PET substrate thereby obtaining a decorative board. The obtained decorative board had a plating tone finish and had even silver metallic luster as observed in using a spattering process.

### Comparative Example 1

In the manufacturing steps of Example 1, a spattering method was applied making acrylic resin which does not contain a cross-linking agent. However, silver building up on a primer layer could not be observed.

### Comparative Example 2

In the manufacturing steps of Example 2, a vapor deposition method was applied making acrylic resin which does not contain a cross-linking agent. However, silver building up on a primer layer could not be observed.

As above mentioned, since the present invention provides a decorative film-like material having a design effect with a plating tone which has not been realized by a decorative film-like material disclosed in the Japanese Unexamined Patent Publication 2001-1483 with good workability, better design can be provided. For this reason, the decorative film-like material of the present invention can preferably be used not only for construction components including walls, column, and doors, for billboards or signs as well as exteriors and interiors of vehicles and vessels including automobile mirror parts and bumper parts, or bodies, and the like.

While illustrative embodiments of the present invention have been described herein, the present invention is not limited to the various preferred embodiments described herein, but includes any and all embodiments having modifications, omissions, combinations (e.g., of aspects across various embodiments), adaptations and/or alterations as would be appreciated by those in the art based on the present disclosure. The limitations in the claims are to be interpreted broadly based the language employed in the claims and not limited to examples described in the present specification or during the prosecution of the application, which examples are to be construed as non-exclusive. For example, in the present disclosure, the term “preferably” is non-exclusive and means “preferably, but not limited to.” Means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited.

What is claimed is:

1. A decorative film-like material, comprising:
a primer layer;
a decorative layer formed on said primer layer; and
a curable resin layer formed on said decorative layer;
wherein said curable resin layer is a layer selected from the group consisting of a heat-curable resin layer and a radiation-curable resin layer, and
wherein said decorative layer includes a metal thin layer.

2. The decorative film-like material as recited in claim 1, wherein said curable resin layer is a cured resin layer formed by curing a curable resin applied on a surface of said decorative primer layer.

3. The decorative film-like material as recited in claim 1, wherein said primer layer is a resin layer formed by printing a resin on a releasing sheet, and has a release characteristic to said releasing sheet.

4. The decorative film-like material as recited in claim 1, wherein said primer layer includes a cross-linking agent.

5. The decorative film-like material as recited in claim 1, wherein said metal thin layer has a thickness of less than 10 ▪m.

6. Automobile parts on which said decorative film-like material as recited in claim 1 is adhered.

7. An automobile, comprising:
an automobile body; and
a decorative film-like material as a coating layer adhered on a surface of said automobile body via an adhesive layer,
wherein said decorative film-like material includes a primer layer, a decorative layer formed on said primer layer and a curable resin layer formed on said decorative layer, said curable resin layer being a layer selected from the group consisting of a heat-curable layer and a radiation-curable resin layer, and said decorative layer including a metal thin layer, and
wherein said adhesive layer is disposed between said primer layer and said surface of said automobile body.

8. A method for manufacturing a decorative film-like material, comprising:
printing a resin including a cross-linking agent on a releasing surface of a releasing sheet to thereby form a primer layer having a releasing property;
forming a decorative layer as a metal thin layer on said primer layer by a spattering method;
applying a curable resin selected from the group consisting of a heat-curable resin and a radiation-curable resin on said decorative layer in a state that said primer layer on which said decorative layer is formed is adhered to said releasing sheet; and
curing said curable resin applied on said decorative layer to thereby form a cured resin layer.

9. A method for manufacturing a decorative film-like material, comprising:
printing a resin including a cross-linking agent on a releasing surface of a releasing sheet to form a primer layer having a releasing property;
forming a decorative layer as a metal thin layer on said primer layer by a deposition method;
applying a curable resin selected from the group consisting of a heat-curable resin and a radiation-curable resin on said decorative layer in a state that said primer layer on which said decorative layer is formed is adhered to said releasing sheet; and
curing said curable resin applied on said decorative layer to thereby form a cured resin layer.
